(19) United States
(12) Patent Application Publication
(10) Pub. No.: US 2006/0107465 A1
(43) Pub. Date: May 25, 2006

(54) Combined tool and sharpener

(76) Inventor: Christopher M. Pomey, Whitmore Lake, MI (US)

Correspondence Address: SEYFARTH SHAW LLP, 55 E. MONROE STREET, SUITE 4200, CHICAGO, IL, 60603-5803, US

(21) Appl. No.: 11/167,873

(22) Filed: Jun. 27, 2005

(51) Int. Cl. B25D 1/04; B26B 11/00

(52) U.S. Cl. 7/144; 7/160

(57) ABSTRACT

A tool and a method for making a tool that includes a handle and a work implement attached to the handle. A writing instrument sharpener is attached to the handle. A kit that includes a tool including a work implement attached to a handle and a writing instrument sharpener. The handle is adapted to have the writing instrument sharpener attached thereto. A method of sharpening a writing instrument in which an end of the writing instrument is placed within an opening located on a tool handle to engage the writing instrument with a sharpener located within the tool handle. The writing instrument is then rotated.

### BACKGROUND

The practice of most professions requires the use of a writing instrument of some sort. Perhaps the most common writing instrument is the common ink pen. In some professions, however, it is necessary or advantageous to use a writing instrument that needs periodic sharpening, such as a pencil. The reasons for this vary by profession. For instance, in one profession it might be desirable to use an instrument that is erasable. In another profession, it might be desirable to use an instrument that is inexpensive and can be easily replaced if lost. Pencils fit this category.

A disadvantage of pencils is that to sharpen them one must use a pencil sharpener. If the pencil sharpener is lost or misplaced, the pencils will eventually become useless. Accordingly, what is needed is a pencil sharpener that can not be easily lost or misplaced.

### SUMMARY

In one example, the application discloses a tool. The tool includes a handle and a work implement attached to the handle. A writing instrument sharpener is attached to the handle.

In another example the application discloses a method of making a tool. The method includes selecting a work implement that is attached to a handle attaching a writing instrument sharpener to the handle.

In another example, the application discloses a kit. The kit includes a tool including a work implement attached to a handle and a writing instrument sharpener. The handle is adapted to have the writing instrument sharpener attached thereto.

In another example, the application discloses a method of sharpening a writing instrument. An end of the writing instrument is placed within an opening located on a tool handle to engage the writing instrument with a sharpener located within the tool handle. The writing instrument is then rotated.

### BRIEF DESCRIPTION OF THE DRAWINGS

FIG. 1 shows an elevated side partial cutaway view of a tool having a writing instrument sharpener attached thereto.

### DETAILED DESCRIPTION

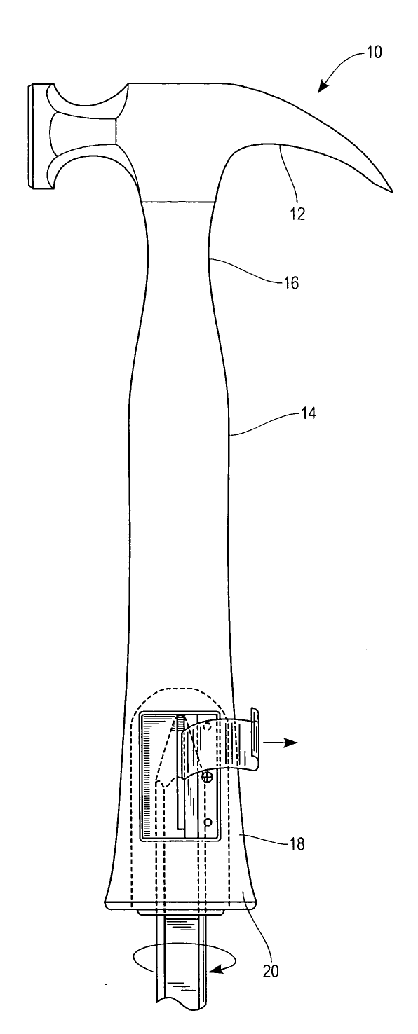

Referring to FIG. 1, one example, a tool 10 is disclosed. The tool 10 includes a work implement 12 attached to a handle 14. In one example, the tool 10 is a hammer. Accordingly, the work implement 12 will be a hammerhead. The hammerhead could be made of wood, metal, rubber, or any material sufficient to allow it to achieve its purpose. The handle 14 can be made of wood, metal, rubber, plastic or any other material sufficient to allow it to act as a handle. The handle 14 can be attached to work implement 12 through any known means.

It should be noted that the preceding description is not meant to limit the tool 10 to that shown in FIG. 1. In another example, the tool could be a saw, a screwdriver, a mallet, or another such implement that includes a work implement of some sort and a handle.

Handle 14 includes a first end 16 and a second end 18. The first end 16 is attached to the work implement 12. The second end 18 includes an opening 20 formed therein. A writing instrument sharpener 22 is positioned in the opening 20. In one example, the writing instrument sharpener is a standard lead pencil sharpener. In another example, writing instrument sharpener is a sharpener for the thick gauge lead pencils that are used by construction workers. In a further example, the sharpener is a crayon or grease pencil sharpener. The preceding description for illustrative purposes only and is not meant to limit the sharpener to a particular type.

Opening 20 should be shaped and dimensioned to receive sharpener 22. If the handle 14 is wood, opening 20 can be formed by boring a hole in the end of handle 14 that is of sufficient size to receive sharpener 22. Sharpener 22 can then be attached to handle by friction fit, press fit, adhesives, fasteners, etc. Alternatively, opening 20 can be formed at another location of handle 14. Also, if the handle 14 is made of another material in which it is difficult to bore a hole, the opening 20 could be formed by other means, e.g. by fabricating the handle 14 to include the opening 20. As yet another alternative, the sharpener 22 does not actually need to reside inside of the handle 14. Instead, the sharpener 22 could be attached to the exterior of the handle 14.

In use, the work implement 12 of tool 10 can be used in the usual manner for its primary. For instance, a user can pound nails into wood using the hammerhead. If the user is utilizing a carpentry pencil 24 and needs to sharpen it, the user simply inserts the working end of the pencil 24 into the opening 20 at the end 18 of the handle 14. The user then rotates the pencil 24 and the pencil is sharpened. A similar method can be used for other types of writing instruments.

While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. A tool, comprising:
a handle;
a work implement attached to the handle; and
a writing utensil sharpener attached to the handle.

2. The tool of claim 1, wherein the handle comprises a shaft.

3. The tool of claim 2, wherein the shaft is wooden.

4. The tool of claim 3, wherein the shaft includes an opening and the sharpener is positioned in the opening.

5. The tool of claim 2, wherein the shaft includes a first end and a second end with the work implement positioned at the first end and the sharpener positioned at the second end.

6. The tool of claim 1, wherein the work implement is attached integrally to the handle.

7. The tool of claim 1, wherein the work implement is a hammer.

8. The tool of claim 1, wherein the sharpener is a pencil sharpener.

9. The tool of claim 8, wherein the sharpener is a pencil sharpener adapted to sharpen carpentry pencils.

10. The tool of claim 1, wherein the handle comprises a wooden shaft having a first end and a second end; the work implement includes a hammer positioned at the first end;
the second end includes an opening; and the sharpener is a carpentry pencil sharpener positioned in the opening.

11. A method of making a tool, comprising:
selecting a work implement that is attached to a handle, and
attaching a writing instrument sharpener to the handle.

12. The method of claim 11, wherein the step of selecting comprises:
selecting a work implement that is attached to a wooden shaft.

13. The method of claim 12, wherein the wooden shaft has a first end and a second end, the work implement is attached to the first end, and the step of attaching comprises:
attaching the sharpener to the second end.

14. The method of claim 12, wherein the step of attaching comprises:
forming an opening in the wooden shaft, and
positioning the sharpener in the opening.

15. The method of claim 11, wherein the step of selecting comprises:
selecting a hammer.

16. The method of claim 11, wherein the step of attaching comprises:
attaching a pencil sharpener to the handle.

17. A kit, comprising:
a tool including a work implement attached to a handle; and
a writing instrument sharpener, wherein the handle is adapted to have the writing instrument sharpener attached thereto.

18. A method of sharpening a writing instrument, the method comprising:
placing an end of the writing instrument within an opening located on a tool handle to engage the writing instrument with a sharpener located within the tool handle, and
rotating the writing instrument.

19. The method of claim 18, wherein the tool handle is connected to a hammer.

20. The method of claim 18, wherein the sharpener is a pencil sharpener.
